(19) United States
(12) Patent Application Publication
(10) Pub. No.: US 2026/0279855 A1
(43) Pub. Date: Sep. 17, 2026

(54) FUEL CELL SYSTEM

(71) Applicant: TOYOTA JIDOSHA KABUSHIKI KAISHA, Toyota=shi (JP)

(72) Inventor: Jumpei SHIODA, Nagakute-shi (JP)

(73) Assignee: TOYOTA JIDOSHA KABUSHIKI KAISHA, Toyota-shi (JP)

(21) Appl. No.: 19/418,728

(22) Filed: Dec. 12, 2025

(30) Foreign Application Priority Data
Mar. 12, 2025 (JP) 2025-039746

(51) Int. Cl. H01M 8/04111; H01M 8/04082; H01M 8/04746; H01M 8/04858

(52) U.S. Cl. CPC H01M 8/04111; H01M 8/04201; H01M 8/04753; H01M 8/04947

(57) ABSTRACT

A fuel cell system includes: an FC stack;, a compressor having an air bearing; a battery; a valve; and a controller. When fuel supply to the FC stack is stopped because a state of charge of the battery is equal to or higher than a predetermined state of charge, the controller executes a stack protection control in which less air is supplied to the FC stack than when fuel is being supplied. The stack protection control includes: a first control in which the compressor is rotated at a rotational speed lower than a floating rotational speed of the air bearing and the valve is fixed at a predetermined opening degree; and a second control in which the compressor is rotated at a rotational speed equal to or higher than the floating rotational speed and the valve is adjusted to an opening degree smaller than the predetermined opening degree.

### CROSS-REFERENCE TO RELATED APPLICATION

This application claims priority to Japanese Patent Application No. 2025-039746 filed on Mar. 12, 2025. The disclosure of the above-identified application, including the specification, drawings, and claims, is incorporated by reference herein in its entirety.

### BACKGROUND

### 1. Technical Field

The present disclosure relates to a fuel cell system.

### 2. Description of Related Art

In a fuel cell system, when an air compressor is in an idling operation at a level where an air bearing does not float, wear due to solid contact may occur. Therefore, it is known that the rotational speed of the air bearing is appropriately controlled in order to suppress the wear (for example, see Japanese Unexamined Patent Application Publication No. 2021-514045 (JP 2021-514045 A)).

### SUMMARY

An object of the present disclosure is to extend the service life of a fuel cell system.

One aspect of the present disclosure is a fuel cell system including:

a fuel cell (FC) stack;

a compressor having an air bearing;

a battery;

a valve configured to adjust an amount of air to be supplied to the FC stack; and

a controller configured to control the compressor and the valve, in which

the controller is configured to execute, when a supply of fuel to the FC stack is stopped because a state of charge of the battery is equal to or higher than a predetermined state of

charge, a stack protection control in which less air is supplied to the FC stack than when the fuel is being supplied; and

the stack protection control includes

a first control in which the compressor is rotated at a rotational speed lower than a floating rotational speed of the air bearing and the valve is fixed at a predetermined opening degree to supply less air than when the fuel is being supplied, and

a second control in which the compressor is rotated at a rotational speed equal to or higher than the floating rotational speed of the air bearing and the valve is adjusted to an opening degree smaller than the predetermined opening degree to supply less air than when the fuel is being supplied.

According to the present disclosure, the service life of a fuel cell system can be extended.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a fuel cell system according to a first embodiment;

FIG. 2 is a time chart showing a relationship between a state of charge (SOC) of the battery and an execution state of the first control and the second control when the controller executes the stack protection control;

FIG. 3 is a flowchart showing a control flow in an electronic control unit (ECU) according to the first embodiment;

FIG. 4 is a flowchart showing a control flow in an ECU according to a second embodiment; and

FIG. 5 is a flowchart showing a control flow in an ECU according to a third embodiment.

### DETAILED DESCRIPTION OF EMBODIMENTS

In the fuel cell system, the power generation is stopped by stopping the supply of the fuel when the battery is in a fully charged state. In this case, since there is a concern that the catalyst of the FC stack deteriorates, a small amount of air is supplied to the FC stack. As described above, the control in which the deterioration of the FC stack is suppressed by supplying a small amount of air to the FC stack is referred to as a stack protection control hereinafter. The stack protection control requires that less air be supplied to the FC stack than during power generation. In addition, in the stack protection control, there is a concern that the deterioration of the catalyst proceeds when the air supplied to the FC stack is too small or too large.

In a case of supplying a small amount of air to the FC stack, the following two methods are considered. The first method is a method of decreasing the rotational speed of the air compressor. However, when the rotational speed of the compressor decreases, the rotational speed of the air compressor becomes lower than the floating rotational speed of the air bearing, and the wear of the air bearing proceeds. When the compressor fails due to the wear of the air bearing, the service life of the fuel cell system is shortened. The second method is to restrict the flow rate of the air by the valve while rotating the compressor at a rotational speed equal to or higher than the floating rotational speed of the air bearing. However, when the opening degree of the valve is adjusted in a state where the opening degree of the valve is small, the wear of the seat rubber that increases the sealing performance of the valve proceeds. When the valve fails due to the wear of the seat rubber, the service life of the fuel cell system is shortened.

Therefore, one aspect of the present disclosure is a fuel cell system including: a controller configured to execute a stack protection control when the supply of the fuel to the FC stack is stopped because a state of charge of the battery is equal to or higher than a predetermined state of charge. In the stack protection control, less air is supplied to the FC stack than when the fuel is being supplied. The fuel cell system includes a first control in which the compressor is rotated at a rotational speed lower than a floating rotational speed of the air bearing and the valve is fixed at a predetermined opening degree to supply less air than when the fuel is being supplied. The fuel cell system includes a second control in which the compressor is rotated at a rotational speed equal to or higher than the floating rotational speed of the air bearing and the valve is adjusted to an opening degree smaller than the predetermined opening degree to supply less air than when the fuel is being supplied. The floating rotational speed is a rotational speed of an impeller or a rotation shaft, and is a rotational speed at which mechanical friction does not occur.

In the first control, air is supplied to the FC stack by the first method. In the second control, air is supplied to the FC stack by the second method. The first control and the second control may be executed in order in one stack protection control. The order in this case may be either the first control or the second control. In addition, the controller may end one control of the first control and the second control and start the other control of the first control and the second control at a point in time when a predetermined time has elapsed after the one control of the first control and the second control is started. Further, the controller may execute the other control until the state of charge of the battery decreases to a threshold value at which charging is started.

In addition, the controller is configured to execute the stack protection control using only one control of the first control and the second control. The controller may execute the stack protection control using only the other control of the first control and the second control after a predetermined period has elapsed. The predetermined period may be a period for executing the stack protection control once or a period for executing the stack protection control a plurality of times. In addition, the predetermined period may be a period in which half of a period assumed as the service life of the fuel cell system has elapsed. Therefore, the controller may switch between the first control and the second control each time the stack protection control is executed. In addition, the controller may execute only one control of the first control and the second control a plurality of times when executing the stack protection control, and may execute only the other control of the first control and the second control after the predetermined period has elapsed.

As described above, by distributing the stack protection control proportionally between the first control and the second control, the deterioration of the FC stack when the power generation is not being performed in the fuel cell system can be suppressed. In addition, the fuel cell system can suppress a premature end of the service life of either the air compressor or the valve. As a result, the service life of the fuel cell system as a whole can be extended.

Hereinafter, embodiments for implementing the present disclosure will be described in detail with reference to the drawings. However, unless otherwise specified, the dimensions, materials, shapes, relative arrangements, and the like of the components described in this embodiment are not intended to limit the scope of the present disclosure to only these.

### First Embodiment

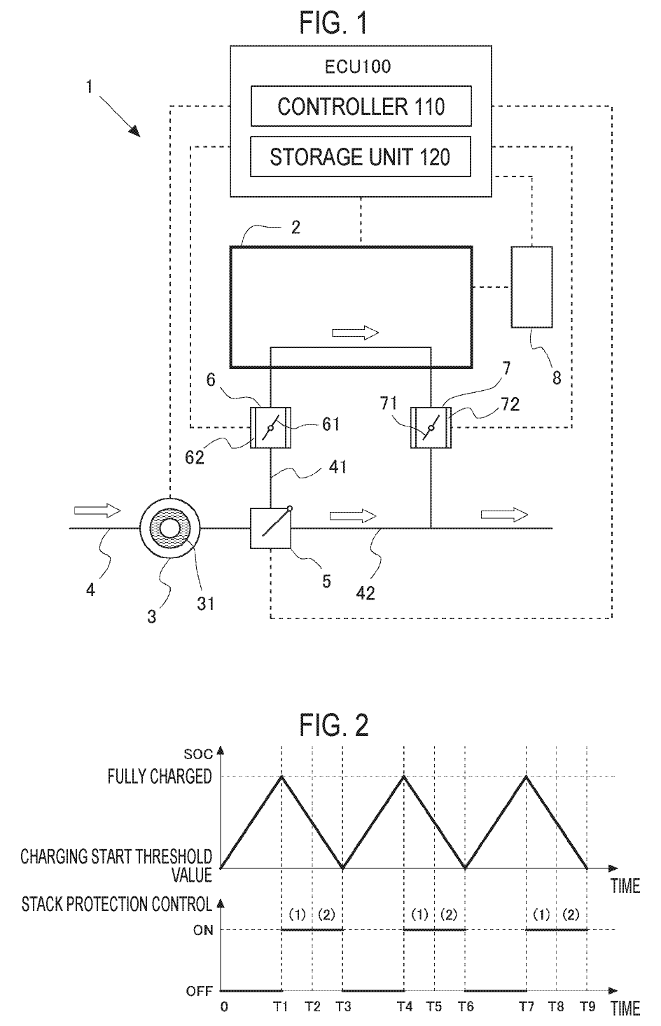

FIG. 1 is a diagram schematically showing a fuel cell system according to a first embodiment. The fuel cell system 1 includes an FC stack 2, an air compressor 3, an air passage 4, a first valve 5, a second valve 6, a third valve 7, a battery 8, and an ECU 100. The fuel cell system 1 is, for example, a system mounted on a fuel cell vehicle (FCV). The hollow arrows in FIG. 1 indicate a direction in which air flows.

The FC stack 2 is a structure having a plurality of FC cells that perform power generation using, for example, hydrogen and oxygen contained in air. The battery 8 is a secondary battery that stores electricity generated by the FC stack 2. The air compressor 3 is an electric turbo type compressor having a bearing using an air bearing 31. The air bearing 31 is a non-contact bearing that reduces frictional resistance by floating a rotation shaft or an impeller by air pressure.

The air passage 4 is a passage that supplies air discharged from the air compressor 3 to an air electrode of the FC stack 2. The air passage 4 branches, downstream of the air compressor 3, into a stack-side passage 41 that passes through the FC stack 2 and a bypass passage 42 that bypasses the FC stack 2. A first valve 5 that distributes air to the stack-side passage 41 and the bypass passage 42 is disposed at a portion where the stack-side passage 41 and the bypass passage 42 are branched in the air passage 4. The first valve 5 is a valve that allows air to flow only through the stack-side passage 41 when fully closed, and increases the amount of air flowing through the bypass passage 42 as the opening degree increases. When the first valve 5 is fully opened, air flows through both the stack-side passage 41 and the bypass passage 42.

The second valve 6, the FC stack 2, and the third valve 7 are disposed in the stack-side passage 41 in order from the first valve 5 side. In addition, the stack-side passage 41 merges with the bypass passage 42 downstream of the third valve 7.

The second valve 6 is a valve that adjusts the flow rate of air flowing through the stack-side passage 41 by adjusting the area of the air flow passage. The second valve 6 has a valve body 61 and a seat rubber 62 that comes into contact with the valve body 61 when fully closed to enhance the sealing performance. The third valve 7 is a valve that adjusts the flow rate of air flowing through the stack-side passage 41 by adjusting the area of the air flow passage. The third valve 7 has a valve body 71 and a seat rubber 72 that comes into contact with the valve body 71 when fully closed to enhance the sealing performance. At least one of the second valve 6 and the third valve 7 may be disposed.

The FC stack 2, the air compressor 3, the air passage 4, the first valve 5, the second valve 6, the third valve 7, and the battery 8 are connected to the ECU 100 via electrical wiring. The ECU 100 is a computer that controls the fuel cell system 1, and adjusts at least the amount of air to be supplied to the FC stack 2. The ECU 100 includes a controller 110 and a storage unit 120. The controller 110 can be implemented by, for example, a hardware processor such as a CPU. In addition, the controller 110 may be configured to include RAM, a read only memory (ROM), cache memory, and the like. The storage unit 120 is a unit that stores information, and is configured by a storage medium such as RAM or flash memory. The storage unit 120 stores a program executed by the controller 110, data used by the program, and the like.

The controller 110 supplies a small amount of air to the FC stack 2 when the battery 8 is fully charged or close to being fully charged. Here, the small amount refers to an amount smaller than the amount of air to be supplied during power generation by the FC stack 2. Since power generation is not necessary when the battery 8 is fully charged, the fuel efficiency can be improved by stopping the power generation. However, it is known that, when oxygen is no longer supplied to the FC stack 2, the voltage of the FC cell decreases and the catalyst (for example, Pt) deteriorates (for example, becomes metallized). In addition, it is also known that, when oxygen is excessively supplied in this case, the voltage of the FC cell increases and the deterioration of the catalyst (for example, Pt elution) proceeds. On the other hand, by supplying less oxygen than the oxygen necessary for power generation, the deterioration of the FC stack 2 can be suppressed.

As a method of supplying a small amount of oxygen to the FC stack 2, it is conceivable to operate the air compressor 3 at a reduced rotational speed. In addition, as a method of supplying a small amount of oxygen to the FC stack 2, it is conceivable to adjust the amount of air to be supplied by controlling the opening degrees of the first valve 5, the second valve 6, and the third valve 7 while keeping the rotational speed of the air compressor 3 to be equivalent to the rotational speed during power generation.

Here, when the controller 110 reduces the rotational speed of the air compressor 3 in order to supply a small amount of air to the FC stack 2, the rotational speed becomes lower than the floating rotational speed of the air bearing 31. As a result, the air bearing 31 wears. When the air compressor 3 fails due to the wear of the air bearing 31, the service life of the fuel cell system 1 may be shortened.

In addition, when the controller 110 operates the air compressor 3 at a rotational speed equal to or higher than the floating rotational speed and adjusts the opening degrees of the first valve 5, the second valve 6, and the third valve 7, it is necessary to control the opening degree of the second valve 6 or the third valve 7 to a small opening degree close to fully closed. Therefore, in the second valve 6, the seat rubber 62 wears due to contact between the valve body 61 and the seat rubber 62, or in the third valve 7, the seat rubber 72 wears due to contact between the valve body 71 and the seat rubber 72. When the second valve 6 or the third valve 7 fails due to the wear of the seat rubber 62 of the second valve 6 or the seat rubber 72 of the third valve 7, the service life of the fuel cell system 1 may be shortened.

Therefore, in a case of supplying a small amount of air to the FC stack 2, the controller 110 executes a first control in which a small amount of air is supplied to the FC stack 2 by setting the rotational speed of the air compressor 3 to be lower than the floating rotational speed. In addition, the controller 110 executes a second control in which a small amount of air is supplied to the FC stack 2 by adjusting the opening degrees of the first valve 5, the second valve 6, and the third valve 7 while keeping the rotational speed of the air compressor 3 to be equal to or higher than the floating rotational speed, and distributes the supply proportionally between these controls. The control in which a small amount of air is supplied to the FC stack 2 when the power generation is not performed is referred to as a stack protection control hereinafter.

In the first control, the controller 110 fully closes the first valve 5 to block the flow of air to the bypass passage 42. In addition, the controller 110 adjusts the opening degrees of the second valve 6 and the third valve 7 to be, for example, fully open. Further, the controller 110 controls the rotational speed of the air compressor 3 in a range in which the rotational speed of the air compressor 3 is lower than the floating rotation speed and supplies a predetermined amount of air to the FC stack 2. The predetermined amount is an amount of air that can suppress the deterioration of the FC stack 2.

In the second control, the controller 110 fully opens the first valve 5, for example, to allow air to flow to the stack-side passage 41 and the bypass passage 42. In addition, the controller 110 operates the air compressor 3 at a rotational speed equal to or higher than the floating rotation speed. Further, the controller 110 controls the opening degree of one valve of the second valve 6 and the third valve 7 such that the valve is opened within a range that does not cause wear on the seat rubber 62 of the second valve 6 or the seat rubber 72 of the third valve 7. In addition, the controller 110 adjusts the opening degree of the other valve of the second valve 6 and the third valve 7 to supply a predetermined amount of air to the FC stack 2. In this case, the opening degree of the other valve adjusted by the controller 110 is a small opening degree, and the seat rubber 62 of the second valve 6 or the seat rubber 72 of the third valve 7 wears during adjustment of this opening degree.

FIG. 2 is a time chart showing a relationship between the state of charge (SOC) of the battery 8 and the execution state of the first control and the second control when the controller 110 executes the stack protection control. A time from 0 to T1 is a time during which normal power generation control is executed to increase the SOC of the battery 8. The normal power generation control refers to control in which an amount of fuel (for example, hydrogen) and air necessary for power generation are supplied to the FC stack 2. In this case, the controller 110 supplies an amount of air necessary for power generation to the FC stack 2 by keeping the rotational speed of the air compressor 3 equal to or higher than the floating rotational speed and adjusting the opening degrees of the first valve 5, the second valve 6, and the third valve 7. The controller 110 may acquire the amount of air supplied to the FC stack 2 according to, for example, a detection value of a flow rate sensor or a pressure sensor disposed in the stack-side passage 41.

T1 in FIG. 2 is a point in time when the SOC of the battery 8 reaches a value corresponding to the fully charged state. From the point in time T1, the normal power generation control is ended, and the stack protection control is started. From the point in time T1, the SOC of the battery 8 decreases due to consumption by, for example, a drive motor of the vehicle. In the stack protection control, first, the first control is executed. In the present embodiment, in one stack protection control, the first control and the second control are executed in order. In FIG. 2, a time during which the first control is executed is indicated by (1). A time from T1 to T2 is a time during which the first control is executed. The time from T1 to T2 may be a fixed value set in advance or a time corresponding to the SOC. For example, T2 may be defined as a point in time when the SOC reaches a value obtained by adding the SOC corresponding to the fully charged state and a charging start threshold value described below, and dividing the sum by two. The time from T1 to T2 is stored in the storage unit 120.

T2 in FIG. 2 is a point in time when the first control is ended and the second control is started. In FIG. 2, a time during which the second control is executed is indicated by (2). A time from T2 to T3 is a time during which the second control is executed. T3 is a point in time when the SOC reaches the charging start threshold value. The charging start threshold value is stored in the storage unit 120 as a threshold value for starting charging of the battery 8. At the point in time T3, the second control is ended, and the normal power generation control is started. Thereafter, during the time from T3 to T9, the normal power generation control, the first control, and the second control are repeatedly executed in order. In the example shown in FIG. 2, in the stack protection control, the controller 110 executes the first control first and then executes the second control, but instead, the controller 110 may execute the second control first and then execute the first control. In the stack protection control, the controller 110 can arbitrarily set the order of executing the first control and the second control.

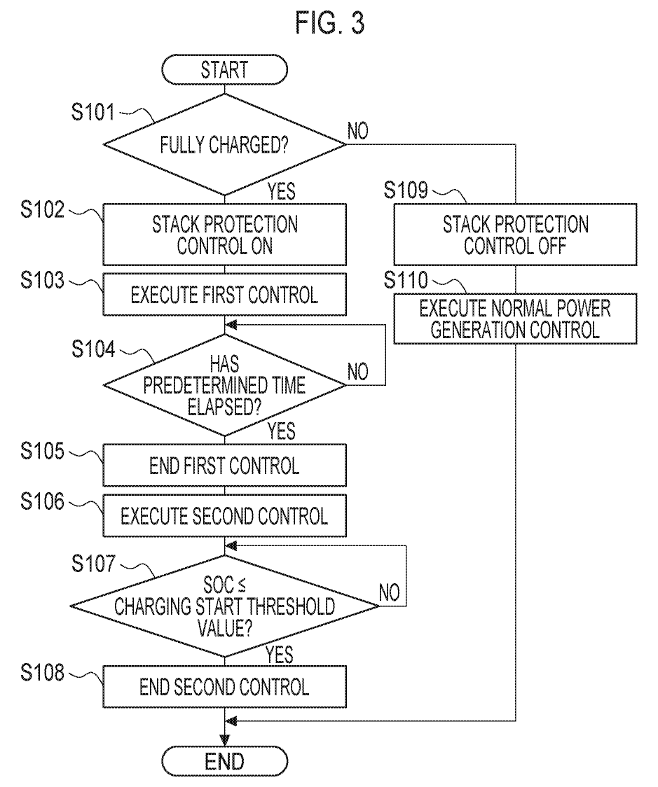

FIG. 3 is a flowchart showing a control flow in the ECU 100 according to the first embodiment. The routine shown in FIG. 3 is repeatedly executed in the ECU 100 at predetermined time intervals. In S101, the controller 110 determines whether the battery 8 is fully charged. As another example, the controller 110 may determine whether the SOC of the battery 8 is equal to or higher than an upper limit threshold value. The upper limit threshold value is stored in the storage unit 120 as an SOC at which the battery 8 does not need to be charged. When the control unit 110 makes an affirmative determination in S101, the process proceeds to S102, and when the control unit 110 makes a negative determination in S101, the process proceeds to S109.

In S102, the controller 110 starts the stack protection control (turns ON). In this case, when the controller 110 has been executing the normal power generation control, the controller 110 ends the normal power generation control. When the processing in S102 is completed, the process proceeds to S103.

In S103, the controller 110 executes the first control. That is, the controller 110 operates the air compressor 3 at a rotational speed lower than the floating rotational speed, adjusts the first valve 5 such that the total amount of air flowing through the air passage 4 flows through the stack-side passage 41, and sets the opening degrees of the second valve 6 and the third valve 7 to, for example, fully open. In this way, the controller 110 supplies an amount of air that is predetermined to be small to the FC stack 2. The controller 110 may execute feedback control of the rotational speed of the air compressor 3 such that the amount of air flowing into the FC stack 2 detected by the sensor is the target amount. When the processing in S103 is completed, the process proceeds to S104.

In S104, the controller 110 determines whether a predetermined time has elapsed after the first control is started. The predetermined time corresponds to the time from T1 to T2 in FIG. 2. When the controller 110 makes an affirmative determination in S104, the process proceeds to S105, and when the controller 110 makes a negative determination in S104, the processing in S104 is executed again.

In S105, the controller 110 ends the first control, and further, in S106, the controller 110 executes the second control. The controller 110 operates the air compressor 3 at a rotational speed equal to or higher than the floating rotational speed and adjusts the first valve 5 such that a small amount of air flowing through the air passage 4 flows through the stack-side passage 41. In addition, the controller 110 opens one of the second valve 6 and the third valve 7 within a range that does not cause wear on the seat rubber 62 and the seat rubber 72, and adjusts the other valve to repeatedly open and close at a minute opening degree. In this way, the controller 110 supplies an amount of air that is predetermined to be small to the FC stack 2. The controller 110 may execute feedback control of the opening degree of the other of the second valve 6 and the third valve 7 such that the amount of air flowing into the FC stack 2 detected by the sensor is the target amount. When the processing in S106 is completed, the process proceeds to S107.

In S107, the controller 110 determines whether the SOC of the battery 8 is equal to or lower than the charging start threshold value. When the controller 110 makes an affirmative determination in S107, the process proceeds to S108, and when the controller 110 makes a negative determination in S107, the processing in S107 is executed again. In S108, the controller 110 ends the second control. When the processing in S108 is completed, the present routine ends.

On the other hand, in S109, when the stack protection control is being executed, the controller 110 ends the stack protection control (turns OFF). When the stack protection control is not being executed, the controller 110 may omit the processing in S109.

In S110, the controller 110 executes the normal power generation control. For normal power generation control, known techniques can be used. When the processing in S110 is completed, the present routine ends.

As described above, according to the present embodiment, the stack protection control can be distributed proportionally between the first control and the second control. As a result, the deterioration of only one of the air compressor 3, the second valve 6, and the third valve 7 proceeds, a premature end of the service life of the fuel cell system 1 as a whole can be suppressed. As a result, the service life of the fuel cell system 1 as a whole can be extended.

### Second Embodiment

In the second embodiment, only the first control is executed in the stack protection control within a predetermined period from when the fuel cell system 1 is new, and only the second control is executed in the stack protection control after the predetermined period has elapsed.

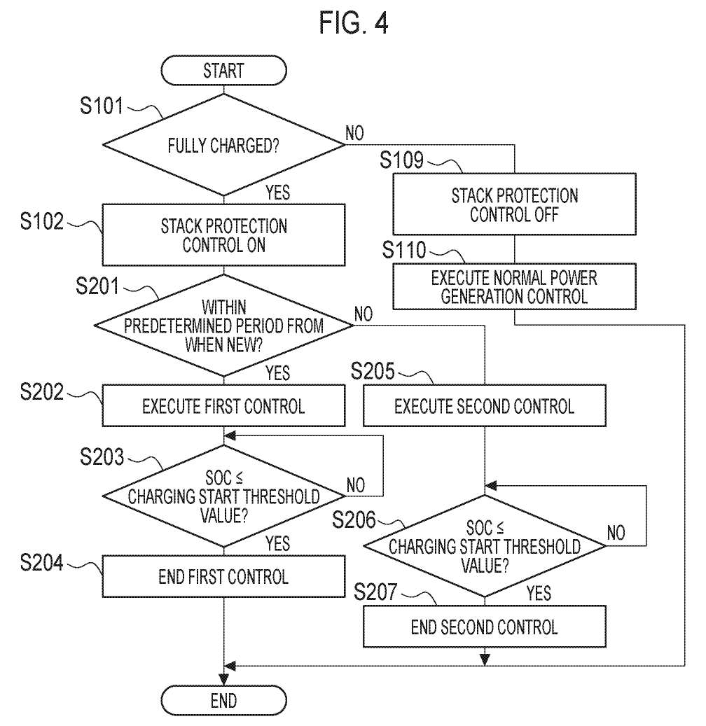

FIG. 4 is a flowchart showing a control flow in the ECU 100 according to the second embodiment. The routine shown in FIG. 4 is repeatedly executed in the ECU 100 at predetermined time intervals. For the steps in which the same processing as the routine shown in FIG. 3 is executed, the same reference numerals are used, and the description thereof is omitted. In the routine shown in FIG. 4, when the processing in S102 is completed, the process proceeds to S201.

In S201, the controller 110 determines whether an operation period of the fuel cell system 1 from the fuel cell system 1 is new is within a predetermined period. The operation period is counted by the controller 110. The predetermined period is, for example, a period corresponding to half of the service life of the fuel cell system 1. The predetermined period may be a period during which the number of rotations of the air compressor 3 is accumulated and the number of rotations reaches a predetermined number of rotations. The predetermined number of rotations is, for example, the number of rotations of the air compressor 3 in a period corresponding to half of the service life of the fuel cell system 1, and is obtained in advance by an experiment, a simulation, or the like and stored in the storage unit 120. That is, in S201, the controller 110 may determine whether the accumulated value of the number of rotations of the air compressor 3 is equal to or less than the predetermined number of rotations. The number of rotations of the air compressor 3 is acquired by the sensor. In using the fuel cell system 1 over a long period of time, the controller 110 executes the stack protection control by the first control in the first half, and the controller 110 executes the stack protection control by the second control in the second half. Therefore, in S201 in which the controller 110 determines whether the first half has elapsed, when the controller 110 makes an affirmative determination, the process proceeds to S202, and when the controller 110 makes a negative determination, the process proceeds to S205.

In S202, the controller 110 executes the first control. Next, in S203, the controller 110 determines whether the SOC of the battery 8 is equal to or lower than the charging start threshold value. When the controller 110 makes an affirmative determination in S203, the process proceeds to S204, and when the controller 110 makes a negative determination in S203, the processing in S203 is executed again. In S204, the controller 110 ends the first control. When the processing in S204 is completed, the present routine ends.

On the other hand, in S205, the controller 110 executes the second control. Next, in S206, the controller 110 determines whether the SOC of the battery 8 is equal to or lower than the charging start threshold value. When the controller 110 makes an affirmative determination in S206, the process proceeds to S207, and when the controller 110 makes a negative determination in S206, the processing in S206 is executed again. In S207, the controller 110 ends the second control. When the processing in S207 is completed, the present routine ends.

In this way, even when the control is switched to the second control after the first control has been executed a plurality of times, a premature end of the service life of any one of the air compressor 3, the second valve 6, and the third valve 7 can be suppressed. Therefore, the service life of the fuel cell system 1 as a whole can be extended. In the routine shown in FIG. 4, the first control is executed first and is switched to the second control after the predetermined period has elapsed, but the order of executing the first control and the second control can be arbitrarily determined.

### Third Embodiment

In the third embodiment, one stack protection control is executed by either the first control or the second control alone. Then, each time the stack protection control is executed once, the controller 110 switches the control to be executed in the stack protection control between the first control and the second control.

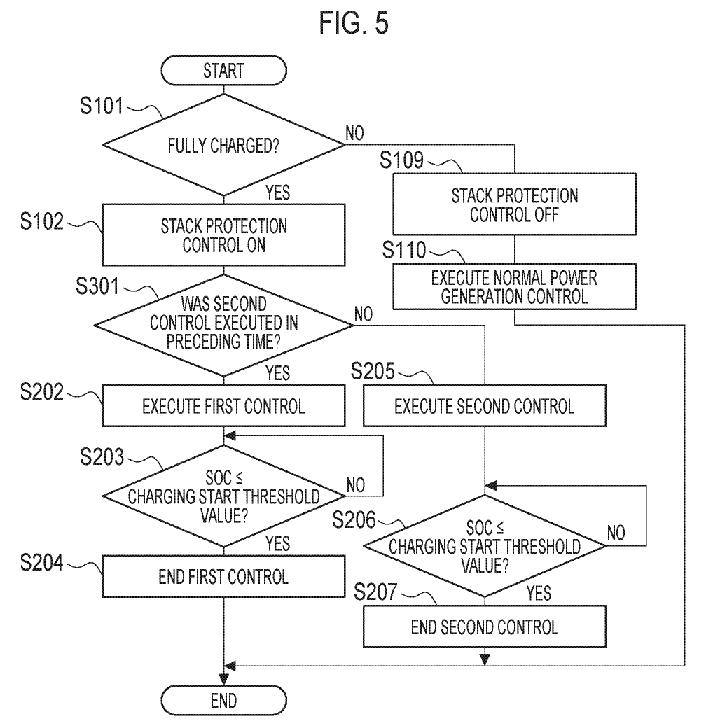

FIG. 5 is a flowchart showing a control flow in the ECU 100 according to the third embodiment. The routine shown in FIG. 5 is repeatedly executed in the ECU 100 at predetermined time intervals. For the steps in which the same processing as the routine shown in FIG. 3 or FIG. 4 is executed, the same reference numerals are used, and the description thereof is omitted. In the routine shown in FIG. 5, when the processing in S102 is completed, the process proceeds to S301.

In S301, the controller 110 determines whether the second control is executed in the preceding stack protection control. When the second control is executed in the preceding stack protection control, the controller 110 executes the first control in the current stack protection control. On the other hand, when the first control is executed in the preceding stack protection control, the controller 110 executes the second control in the current stack protection control. When the controller 110 makes an affirmative determination in S301, the process proceeds to S202, and when the controller 110 makes a negative determination in S301, the process proceeds to S205. The control executed in S202 or S205 is stored in the storage unit 120.

In this way, since the first control and the second control are switched each time the stack protection control is executed, a premature end of the service life of any one of the air compressor 3, the second valve 6, and the third valve 7 can be suppressed. Therefore, the service life of the fuel cell system 1 as a whole can be extended.

What is claimed is:

1. A fuel cell system comprising:
a fuel cell (FC) stack;
a compressor having an air bearing;
a battery;
a valve configured to adjust an amount of air to be supplied to the FC stack; and
a controller configured to control the compressor and the valve, wherein:
the controller is configured to execute, when a supply of fuel to the FC stack is stopped because a state of charge of the battery is equal to or higher than a predetermined state of charge, a stack protection control in which less air is supplied to the FC stack than when the fuel is being supplied; and
the stack protection control includes
a first control in which the compressor is rotated at a rotational speed lower than a floating rotational speed of the air bearing and the valve is fixed at a predetermined opening degree to supply less air than when the fuel is being supplied, and
a second control in which the compressor is rotated at a rotational speed equal to or higher than the floating rotational speed of the air bearing and the valve is adjusted to an opening degree smaller than the predetermined opening degree to supply less air than when the fuel is being supplied.

2. The fuel cell system according to claim 1, wherein the controller is configured to end one control of the first control and the second control and start the other control at a point in time when a predetermined time has elapsed after the one control of the first control and the second control in the stack protection control is started.

3. The fuel cell system according to claim 2, wherein the controller is configured to execute the other control until the state of charge of the battery decreases to a threshold value at which charging is started.

4. The fuel cell system according to claim 1, wherein the controller is configured to execute the stack protection control using only one control of the first control and the second control, and execute the stack protection control using only the other control after a predetermined period has elapsed.

5. The fuel cell system according to claim 1, wherein the controller is configured to,
in the first control, adjust a rotational speed of the compressor while rotating the compressor at the rotational speed lower than the floating rotational speed of the air bearing such that the amount of air to be supplied to the FC stack is a predetermined amount, and
in the second control, adjust an opening degree of the valve while rotating the compressor at the rotational speed equal to or higher than the floating rotational speed of the air bearing such that the amount of air to be supplied to the FC stack is the predetermined amount.
